(19) United States
(12) Patent Application Publication
(10) Pub. No.: US 2005/0019217 A1
(43) Pub. Date: Jan. 27, 2005

(54) Analytical equipment for determining the chemical structure and/or composition of a plurality of samples and sample holder

(76) Inventors: Michael Sander, Taunusstein (DE); Benjamin Wicks, Cambridgeshire (GB); Elisabeth Katherine Hil, Melbourne (AU)

Correspondence Address: NEEDLE & ROSENBERG, P.C., SUITE 1000, 999 PEACHTREE STREET, ATLANTA, GA, 30309-3915, US

(21) Appl. No.: 10/489,368

(22) PCT Filed: Sep. 16, 2002
(86) PCT No.: PCT/DE02/03424

(30) Foreign Application Priority Data
Sep. 14, 2001 (GB) 01222868

(51) Int. Cl. B01L 3/00; G01N 21/64

(52) U.S. Cl. 422/82.05; 422/99

(57) ABSTRACT

The invention relates to the manufacturing of effectively operating analytical equipment for serial examinations, for example, on a genetic material. The fluorescence or luminescence methods are preferred. In order to obtain a good signal-to-noise ratio, it is necessary to keep the excitation light away from the detector and to focus the emission light as much as possible onto said detector. According to the invention, a holder for the samples to be analyzed is provided with an optically active layer, said layer being reflective to the emission light and transparent to the excitation light. When, for example, the sample well of a sample holder is covered with such a layer, the emission light is reflected onto the well walls and bottom and focused on a detector. The excitation light passes through said layer, as far as it does not contribute to a molecular excitation, and is absorbed in said holder.

This invention relates to an analyzer device for determining the chemical structure and/or composition of a plurality of specimens on a carrier on which the specimens to be analyzed are arranged in the form of a matrix, with a light source for illuminating the specimens, whereby the excitation light emitted by the light source is suitable for excitation of the specimen material so that it emits an emission light on its own and with a detector for the emission light.

Such analyzer devices are used in particular in the biological and pharmaceutical fields to perform series tests with a plurality of individual tests on chemical substances. These tests may include, for example, genetic tests in which certain gene sequences are sought, DNA sequence analyses, cell analyses, e.g., in blood tests or analyzes of proteins. In order for this to be done rapidly and economically, the analyzer devices must be designed to be operated at a high throughput.

The test methods used here are based on the fluorescence and luminescence of chemical reagents that are stimulated by light. To do so, the substance to be analyzed is applied in dilute form to a carrier along with the corresponding reagents, e.g., specific labeling substances. Two different types of carriers are used. First, there is the simple glass slide, to which the specimens to be analyzed are applied in the form of small droplets in a uniform two-dimensional matrix. These glass slides or carriers are also known as microarrays. For other tests in which the individual specimens have a larger volume or are liquid, so-called microplates are also used. These involve a plurality of tubular shafts arranged close together and sealed by a bottom on one side. These microplates are made of a plastic material which is generally black, white or transparent, and if the exciting light is emitted from beneath, i.e., through the bottom, they have a transparent bottom. The number of specimens accommodated by such a carrier is between 96 and 1,563, depending on the application.

For analysis, the carrier provided with the specimens is placed in an optical analyzer device in which light sources for excitation of luminescence and/or fluorescence are installed along with detectors and filters. The devices used in the past are used mainly in laboratories. However, there has been an enormous increase in the demand for such analyses, so that the equipment must be further simplified and reduced in size. In particular, the measurement times should be shortened, the specimen quantities should be smaller, and the manufacturing of the equipment should be much more favorable. It is an important point here to improve the signal-to-noise ratio. To achieve this, a larger portion of the emission light must be detected and the excitation light must be kept as far away from the detector as possible.

To solve this problem, the present invention proposes an analyzer device according to the definition of the species of claim 1 having the additional features that the specimen carrier has an optically active layer which acts as a wavelength-selective filter which is adjusted so that the layer preferably reflects light of the wavelength of the emission light.

Instead of the high equipment complexity within the optical analyzer device as was customary in the past, only the carrier itself is provided with a corresponding layer which assumes the functions of lenses and filters which were previously installed separately within the analyzer device. Such coatings can be produced relatively easily and inexpensively so that even when the carriers are to be used only for a single analysis, a cost advantage can be achieved because the analyzer device itself is much simpler and smaller and thus is less expensive to manufacture and maintain.

The effect achieved with this invention can be explained as follows: the emission light is emitted essentially uniformly in all directions so that since the detector can detect only an angular range, only a fraction of the available light is analyzed. With an optically active layer which acts as a mirror for the emission light, the light also goes from other angles in space to the detector, which significantly increases the yield and thus the signal-to-noise ratio.

Furthermore, the layer is transparent for the exciting light itself and therefore, if it does not serve to excite the molecules in the specimen, it is not detected.

To achieve this, the optical property of the layer is adjusted so that it has a first wavelength range with a high transmission rate and a second wavelength range which is different from the former and has a low transmission rate, whereby the excitation light has a wavelength in the first wavelength range and the emission light has a wavelength in the second wavelength range. The layer thus functions as a band pass filter or edge filter which separates the excitation light from the emission light.

A layer having such filter properties can be produced especially easily when it consists of a plurality of layers made of a dielectric material and stacked one above the other. Such layers are also referred to thin film interference coating.

The optically active layer thus consists, for example, of a plurality of individual layers which consists alternately of a material having a high refractive index and a material having a low refractive index, whereby the optical thicknesses of the layers are adjusted so as to form a thin-film interference filter. Depending on their specific structure, such layers function as optical band pass filters or edge filters having a relatively sharp transition between wavelengths which are preferably reflected or preferably transmitted. The transition range amounts to approximately 25 nm and may be adjusted accurately to 1.5%. This is also true of the transition wavelength. The filter properties of the layer are then adjusted so that the transmission rate for the emission light is close to zero, which means that the light is reflected greatly by the layer. On the other hand, if one ensures that the wavelength of the excitation light is within the transmission range of the layer, then it is possible to ensure that this light will not reach the detector.

With the flat specimen carrier mentioned above (microarrays), the layer is either on the top side, i.e., where the specimens are also located, or on the bottom side. For optical reasons, it is particularly favorable to apply the layer to the top side. This is true in particular for the case when the excitation light is emitted into the specimen in a direct light arrangement, i.e., it enters the specimen on the side where the detector is also located. However, it is important to note that the specimens and in particular a few known reagents will react with the layer so that they could be damaged or falsify the measurement. If the specimens and the layer are not chemically compatible, the layer is preferably applied to the bottom side of the carrier.

In the case of a specimen carrier having a plurality of specimen receiving shafts, the inside is preferably provided with the optically active layer. In particular in a direct light arrangement, the shaft walls may be mirrorized and provided with the wavelength-selective layer only on the bottom. This causes the incident excitation light to be reflected into the specimen by the walls of the shaft and thus the excitation rate is reached. The emission light is reflected by the optically active layer at the bottom of the shaft and the mirrorized walls and is thus bundled especially well in the direction of the detector.

This invention also relates to a carrier having an optically active layer:

The optically active layer consists of a plurality of individual layers which consist alternately of a material having a high refractive index and a material having a low refractive index, whereby the optical thicknesses of the layers are adjusted so as to form a thin-film interference filter. Such layers act as optical band pass filters or edge filters having a relatively sharp transition between wavelengths which are preferably reflected or preferably transmitted. The filter properties of the layer are then adjusted so that the transmission rate for the emission light is close to zero, which means that the light is reflected greatly by the layer. On the other hand, if one ensures that the wavelength of the excitation light is within the transmission range of the layer, then it is possible to ensure that this light will not reach the detector. Such layers are also known as thin-film interference coating consisting of a plurality of individual dielectric layers.

The optically active layer is preferably created in a high vacuum by removal of individual molecules. Various methods are available here. However, the carrier must not be heated if it is made of inexpensively manufactured plastic. Therefore according to this invention a plasma-supported or ion-supported electron beam vaporization method is used to produce the layers. Very uniform layers can be applied with a high density by this method, and the spectral properties of the coating can be achieved by a direct visual inspection during application of the layer. This produces a filter having a particularly high quality, i.e., the transition between the wavelengths which are allowed by the filter to pass through and the wavelengths that are reflected is very discrete.

Materials typically used for the coating include silicon oxide (low refractive index) and titanium oxide, tantalum pentoxide (Ta₂O₅) and niobium dioxide (high refractive index). These materials have the advantage that they are largely inert chemically and they do not cause any distortion of the reaction with the substance that is to be detected.

Due to the high density achieved by the coating method, the diffusion of molecules out of the plastic carrier and into the specimens is also effectively suppressed. Furthermore, this achieves layer properties which make the spectral filter properties insensitive to the influence of temperature fluctuations or coming in contact with liquids.

The thicknesses of the individual layers are determined with the help of a computer program so that the spectral properties of the filter are adapted to those of the intended application. In particular the transition wavelength can be determined in advance in this way and adjusted so that it harmonizes with the emission wavelength to be expected.

When applying the layers, they are checked continuously for their thickness so that the calculated layer thickness can be maintained accurately. This yields filters with a sharp transitional range at the predetermined location in the spectrum.

The present invention is explained in greater detail below on the basis of two exemplary embodiments, which show:

FIG. 1 the cross-section through a shallow specimen carrier (microarray);

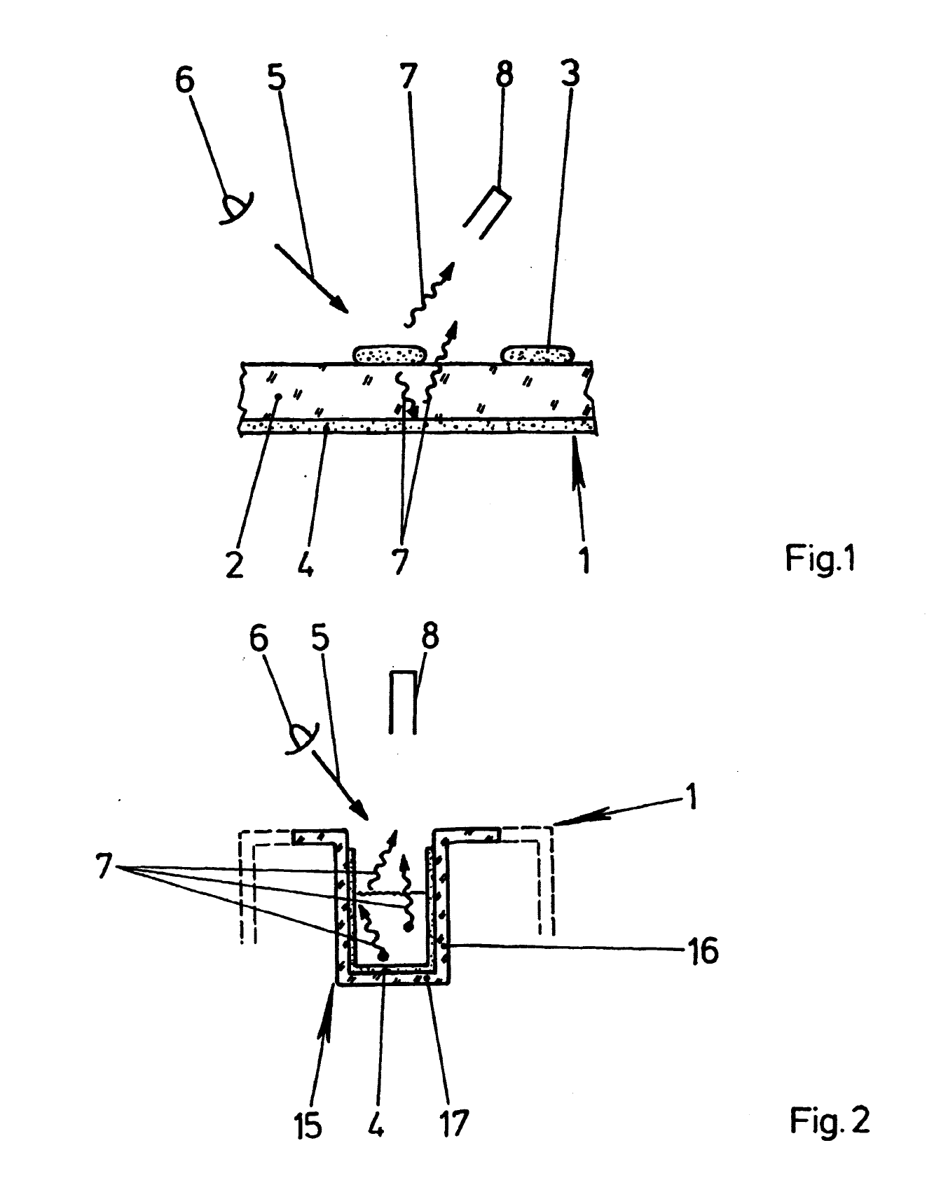

FIG. 2 a cross section through a single shaft of a microplate and

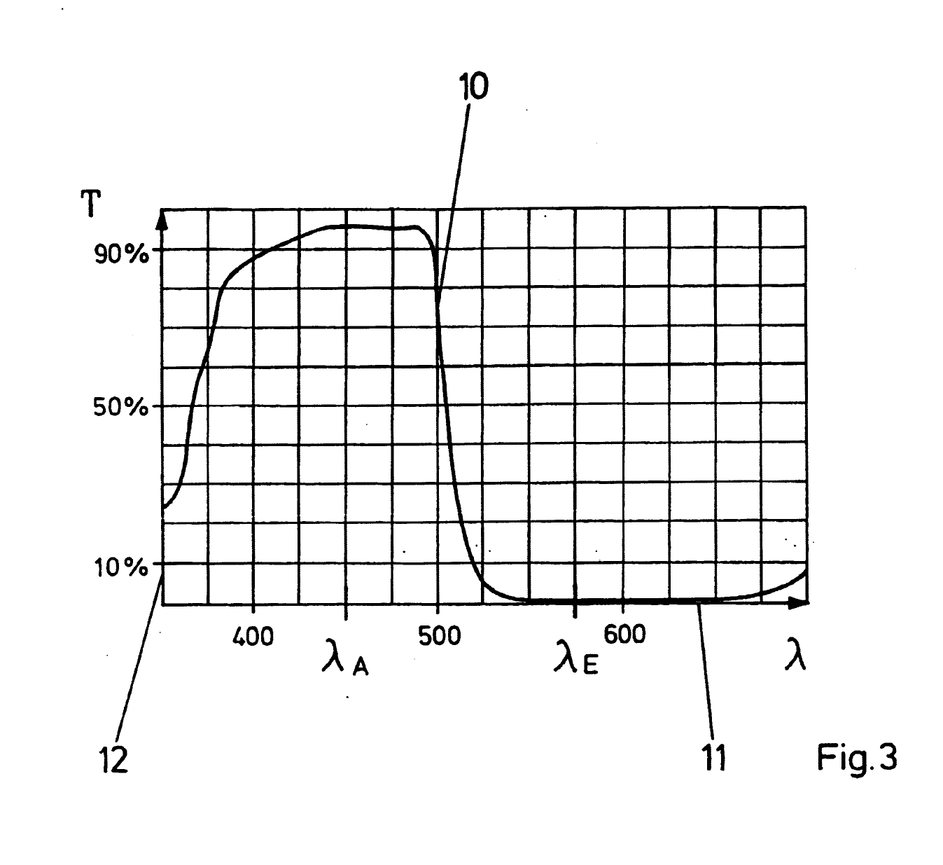

FIG. 3 a typical transmission curve of an optically active layer according to this invention

According to FIG. 1 a carrier 1 consists of a flat glass or plastic slide 2 on the top side of which are applied a plurality of specimens 3 in the form of dots.

The bottom side of the slide 2 is provided with an optically active layer 4 which acts as a filter and which is described in greater detail below.

Excitation light in an incident light configuration (indicated by a straight arrow 5) from an excitation light source 6, e.g., a laser, goes from above onto the carrier 1 which strikes the individual specimens 3. The molecules in the specimen were thereby simulated, i.e., electrons in the molecules would go to a higher energy level and would fall back to their original position after a period of time, so the energy difference is emitted in the form of a photon (indicated by a wavy arrow 7). This photon is detected by a detector 8 situated above the glass plate, thus permitting inferences regarding the type of molecular bond. The analysis in detail is not the object of the present invention and therefore will not be described in greater detail here. A portion of these photons is emitted directly upward into the detector 8; another portion is emitted downward where it strikes the optically active layer 4 and is reflected by it in the direction of the detector 8.

The part of the excitation light that does not lead to excitation of molecules in the specimen passes through the slide 2 and through the optically active layer 4 and thus does not reach the detector 8.

This behavior of the optically active layer is derived from the transmittance curve 10 according to FIG. 3, whereby a wavelength range between 350 and 700 nm is plotted on the X-axis 11, and a transmittance between 0 and 100% is plotted on the Y-axis 12. It can be seen here that in the range of approximately 500 nm, the transmittance drops relatively abruptly from almost 100% to only a few percent. If one ensures that the excitation light has a wavelength λ_{A} below approximately 500 nm, then the transmission will be relatively great for this light, so that it can pass unhindered through the layer 4. The situation is different with the emission light. Its wavelength λ_{E} is above 500 nm so it cannot penetrate through the layer 4, and instead is reflected by it.

As mentioned above, the optically active layer consists of a plurality of individual layers with a great range of variation of refractive index, together forming a thin-film interference filter.

The situation is similar in the case of a carrier plate according to FIG. 2 which consists of a plurality of shafts 15. In this case, both the wall 16 and the bottom 17 of each shaft 15 can be provided with an optically active layer 4. However, as a rule, only the bottom is provided with an optically active layer according to this invention for technical production reasons and the walls are mirrorized so that they reflect both the excitation light as well as the emission light. Here again, the excitation light (arrow 5) strikes the individual molecules and excites them to luminescence and/or fluorescence. The emitted light (arrow 7) is emitted toward all sides and is reflected on the optically active layer 4 and/or on the mirrorized shaft walls, and thus exits from the shaft in bundled form on the open side of the shaft, above which a detector 8 is situated.

If the excitation light does not strike a molecule, it may pass through the layer 4. If the carrier itself is made of dark material, the light is absorbed, resulting in no excitation in the neighboring shafts that would falsify the measurement result.

For the case when the excitation light is directed through the bottom 17 into the specimen from underneath, as an alternative to the embodiment described above, the bottom 17 does not have to have a layer 4 and the carrier may be designed to be transparent at least in the bottom area.

The optically active layer has a thickness of approximately 1.4 μm and is composed of a plurality of individual layers (e.g., 16 or 32) which are alternately made of silicon dioxide and titanium dioxide or tantalum pentoxide or niobium dioxide. Silicon dioxide has a low refractive index, while the other materials have a high refractive index. At the boundary layers, the light is partially reflected and partially diffracted. Depending on the wavelength of the light, this results in constructive and destructive interference. The thickness of the individual layers thus determines which light of a certain wavelength will be reflected more by the layer as a whole and which will pass through the layer. The layer thus has the property of spectral discrimination of light. In the present application, this makes it possible to separate the excitation light from the emission light.

### List of Reference Notation

1 Carrier
2 Slide
3 Specimen
4 Layer
5 Arrow
6 Excitation light source
7 Arrow
8 Detector
10 Transmission curve
11 X-axis
12 Y-axis
15 Layer
16 Wall
17 Bottom

1. Analyzer device for determining the chemical stricture and/or composition of a plurality of specimens on a carrier (1) on which are arranged the specimens to be analyzed in the form of a matrix and having a light source (6) for illuminating the specimens, whereby the excitation light emitted by the light source (6) is suitable for excitation of the specimen material so that first, it emits an emission light, and having a detector (8) for the emission light, characterized in that the specimen carrier (1) has an optically active layer (4) which acts as a wavelength-selective filter which is adjusted so that the layer preferably reflects the light of the wavelength of the emission light:

2. Analyzer device according to claim 1, characterized in that the excitation light has a wavelength for which the optically active layer (4) has a high transmittance.

3. (currently amended) Analyzer device according to claim 1, characterized in that the optical property of the layer is adjusted so that it has a first wavelength range with a high transmission rate and a second wavelength range different from the first and having a low transmission rate, whereby the excitation light has a wavelength in the first wavelength range and the emission light has a wavelength in the second wavelength range.

4. Analyzer device according to claim 3, characterized in that the optically active layer (4) consists of several layers of a dielectric material stacked one above the other.

5. Analyzer device according to claim 1, characterized in that the specimen carrier is a flat strip (2) of a transparent material on one side of which the specimens (3) are applied in the form of a matrix and the other side is provided with the optically active layer (4).

6. Analyzer device according to claim 1, characterized in that the specimen carrier is a carrier having a plurality of specimen receiving shafts (15), the insides of which are provided with the optically active layer (4).

7. Analyzer device according to claim 6, characterized in that the shafts have a bottom (17) and a wall (16) which is perpendicular to the bottom whereby the bottom is transparent and the wall is provided with the optically active layer.

8. Analyzer device according to claim 4, characterized in that the optically active layer consists of a plurality of individual layers which are alternately made of a material having a high refractive index and a material having a low refractive index, whereby the optical thicknesses of the layers are adjusted so as to form a thin-film interference filter.

9. Analyzer device according to claim 8, characterized in that the layers having the low refractive index are made of silicon oxide and the layers having the high refractive index are made of titanium dioxide or tantalum pentoxide or niobium dioxide.

10. Analyzer device according to claim 6, characterized in that the layers are produced with the help of a plasma-supported or ion-supported electron beam vaporization method.

11. Specimen carrier for accommodating a plurality of individual specimens whose chemical structure and/or composition are analyzed by analyzing the emission light emitted by the specimen on the basis of excitation, characterized in that the specimen carrier (1) has an optically active layer (4) which acts as a wavelength-selective filter which is adjusted so that the layer (4) preferably reflects light of the wavelength of the emission light.

12. Specimen carrier according to claim 11, characterized in that the specimen carrier is a flat strip (2) of transparent material, with the specimens (3) being applied to it in the form of a matrix on one side of the strip and the other side is provided with the optically active layer (4).

13. Specimen carrier according to claim 11, characterized in that the specimen carrier (1) is a carrier having a plurality of specimen receiving shafts (15), the insides of which are provided with the optically active layer.

14. Specimen carrier according to claim 11, characterized in that the optically active layer consists of a plurality of individual layers which are alternately made of a material having a high refractive index and a material having a low refractive index.

15. Specimen carrier according to claim 14, characterized in that the layers having the low refractive index are made of silicon oxide, and the layers having the high refractive index are made of titanium dioxide or tantalum pentoxide or niobium dioxide.

16. Specimen carrier according to claim 11, characterized in that the layers are applied with the help of a plasma-supported or ion-supported electron beam vaporization method.
